(19) United States
(12) Patent Application Publication
(10) Pub. No.: US 2026/0135685 A1
(43) Pub. Date: May 14, 2026

(54) TECHNIQUES FOR TIME DIVISION DUPLEXING PATTERNS FOR USER EQUIPMENT WITH FULL SUB-BAND FULL DUPLEX CAPABILITY

(71) Applicant: QUALCOMM Incorporated, San Diego, CA (US)

(72) Inventors: Ahmed Attia ABOTABL, San Diego, CA (US); Muhammad Sayed Khairy ABDELGHAFFAR, San Jose, CA (US); Abdelrahman Mohamed Ahmed Mohamed IBRAHIM, San Diego, CA (US)

(21) Appl. No.: 18/941,803

(22) Filed: Nov. 8, 2024

(51) Int. Cl. H04L 5/14; H04L 27/26

(52) U.S. Cl. CPC H04L 5/1469; H04L 27/2656

(57) ABSTRACT

Various aspects of the present disclosure generally relate to wireless communication. In some aspects, a user equipment (UE) may receive a configuration for sub-band full duplex (SBFD) resources in at least a first time division duplexing (TDD) pattern. The UE may transmit an uplink communication in an SBFD slot or symbol in accordance with the SBFD resources. The UE may receive a downlink communication in the SBFD slot or symbol in accordance with the SBFD resources. Numerous other aspects are described.

### FIELD OF THE DISCLOSURE

Aspects of the present disclosure generally relate to wireless communication and specifically relate to techniques, apparatuses, and methods associated with time division duplexing patterns for a user equipment with full sub-band full duplex capabilities.

### DESCRIPTION OF RELATED ART

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a user equipment (UE) for wireless communication. The UE may include one or more memories and one or more processors coupled to the one or more memories. The one or more processors may be configured to receive a configuration for sub-band full duplex (SBFD) resources in at least a first time division duplexing (TDD) pattern. The one or more processors may be configured to transmit an uplink communication in an SBFD slot or symbol in accordance with the SBFD resources. The one or more processors may be configured to receive a downlink communication in the SBFD slot or symbol in accordance with the SBFD resources.

Some aspects described herein relate to a method of wireless communication performed by a UE. The method may include receiving a configuration for SBFD resources in at least a first TDD pattern. The method may include transmitting an uplink communication in an SBFD slot or symbol in accordance with the SBFD resources. The method may include receiving a downlink communication in the SBFD slot or symbol in accordance with the SBFD resources.

Some aspects described herein relate to a non-transitory computer-readable medium that stores a set of instructions for wireless communication by a UE. The set of instructions, when executed by one or more processors of the UE, may cause the UE to receive a configuration for SBFD resources in at least a first TDD pattern. The set of instructions, when executed by one or more processors of the UE, may cause the UE to transmit an uplink communication in an SBFD slot or symbol in accordance with the SBFD resources. The set of instructions, when executed by one or more processors of the UE, may cause the UE to receive a downlink communication in the SBFD slot or symbol in accordance with the SBFD resources.

Some aspects described herein relate to an apparatus for wireless communication. The apparatus may include means for receiving a configuration for SBFD resources in at least a first TDD pattern. The apparatus may include means for transmitting an uplink communication in an SBFD slot or symbol in accordance with the SBFD resources. The apparatus may include means for receiving a downlink communication in the SBFD slot or symbol in accordance with the SBFD resources.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating examples of full-duplex communication in a wireless network, in accordance with the present disclosure.

FIGS. 4A and 4B are diagrams illustrating examples associated with a configuration for a time division duplexing pattern for a user equipment (UE) with sub-band full duplex (SBFD) capabilities, in accordance with the present disclosure.

FIGS. 5A and 5B are diagrams illustrating examples associated with a configuration for multiple TDD patterns for an SBFD-capable UE, in accordance with the present disclosure.

FIGS. 6A and 6B are diagrams illustrating examples associated with a periodicity of SBFD-UE resources, in accordance with the present disclosure.

FIGS. 7A and 7B are diagrams illustrating examples associated with identifying SBFD-UE resources, in accordance with the present disclosure.

FIG. 8 is a diagram illustrating an example associated with configuring an SBFD-capable UE with a TDD pattern with SBFD-UE resources, in accordance with the present disclosure.

FIG. 9 is a diagram illustrating an example process performed, for example, at a UE or an apparatus of a UE, in accordance with the present disclosure.

FIG. 10 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Time division duplexing (TDD) is a communication technique in a wireless communication system in which transmission and reception operations occur in distinct time intervals on a shared frequency channel. TDD may involve alternating between time periods allocated for uplink communications (e.g., communications from a user equipment (UE) to a network node (e.g., a gNodeB)) and time periods allocated for downlink communications (e.g., communications from the network node to the UE). The allocation of time periods may be controlled by a timing schedule that may specify the duration and sequencing of the uplink and downlink time intervals, in accordance with a TDD pattern, which is a sequence of time intervals that may define alternating periods of uplink communications and/or downlink communications on a shared frequency channel. The TDD pattern may include a series of time slots or subframes, and each time slot or subframe may be allocated for either uplink communications or downlink communications. A UE may be configured with one or more repeating TDD patterns. For example, the UE may be configured with a single repeating TDD pattern. Alternatively, the UE may be configured with two alternating TDD patterns.

Sub-band full duplex (SBFD) is a communication mode in a wireless communication system in which a transmitter and receiver of a wireless device, such as a UE or a network node, may simultaneously transmit and receive signals within a specific sub-band of an available frequency spectrum. In SBFD, a first channel within the sub-band may be allocated for uplink communications (e.g., transmission by the UE) and a second channel within the sub-band may be allocated for downlink communications (e.g., reception by the UE). The channels may be separated by frequency, and the separation between the transmission channel and the reception channel may be configured to reduce interference between transmitted signals and received signals. SBFD can be beneficial in a wireless network. For example, SBFD may increase spectral efficiency, reduce latency, improve throughput, and improve spectrum flexibility.

Even though the channels for SBFD communications are separated, an SBFD-capable UE may include additional components that can help reduce interference. For example, the SBFD-capable UE may be equipped with separate transmission and reception antennas (or panels), a single shared antenna with an enhanced circulator and/or duplexer, one or more analog filters, an analog interference canceller, a reception filter, a digital non-linear interference canceller, and/or a combination thereof, among other examples. Not all UEs in a wireless network may be SBFD-capable UEs, and a network node may not know which UEs, if any, in the wireless network are SBFD-capable. Accordingly, the network node may avoid scheduling SBFD slots in a TDD pattern. By not scheduling SBFD slots in a TDD pattern, the network cannot take advantage of the increase in spectral efficiency, reduced latency, improved throughput, and improved spectrum flexibility to be gained via SBFD communications with SBFD-capable UEs. Further, the network does not have a way to semi-statically indicate, to SBFD-capable UEs via a TDD pattern, time and frequency resources for SBFD communications.

Various aspects relate generally to TDD configurations. Some aspects more specifically relate to TDD patterns for SBFD-capable UEs. In some aspects, the SBFD-capable UEs are configured with TDD patterns that allocate slots for SBFD and non-SBFD communications. In some aspects, the TDD patterns may semi-statically indicate, to SBFD-capable UEs, SBFD time and frequency resources. In some aspects, the TDD patterns may include a first TDD pattern that allocates SBFD resources and a second TDD pattern that does not allocate SBFD resources. In some aspects, SBFD resources for one or more of the TDD patterns may be allocated in accordance with a default SBFD window and/or one or more default SBFD symbols.

Particular aspects of the subject matter described in this disclosure can be implemented to realize one or more of the following potential advantages. In some examples, the described techniques can be used to increase spectral efficiency, reduce latency, improve throughput, and/or improve spectrum flexibility, among other examples. In some aspects, by allocating slots for SBFD communications in the TDD pattern, the network may configure SBFD-capable UEs for SBFD communication even if other UEs in the network are not SBFD-capable. In some aspects, by allocating SBFD resources via a default SBFD window and/or one or more default SBFD symbols, the network can semi-statically configure SBFD-capable UEs for SBFD communication.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

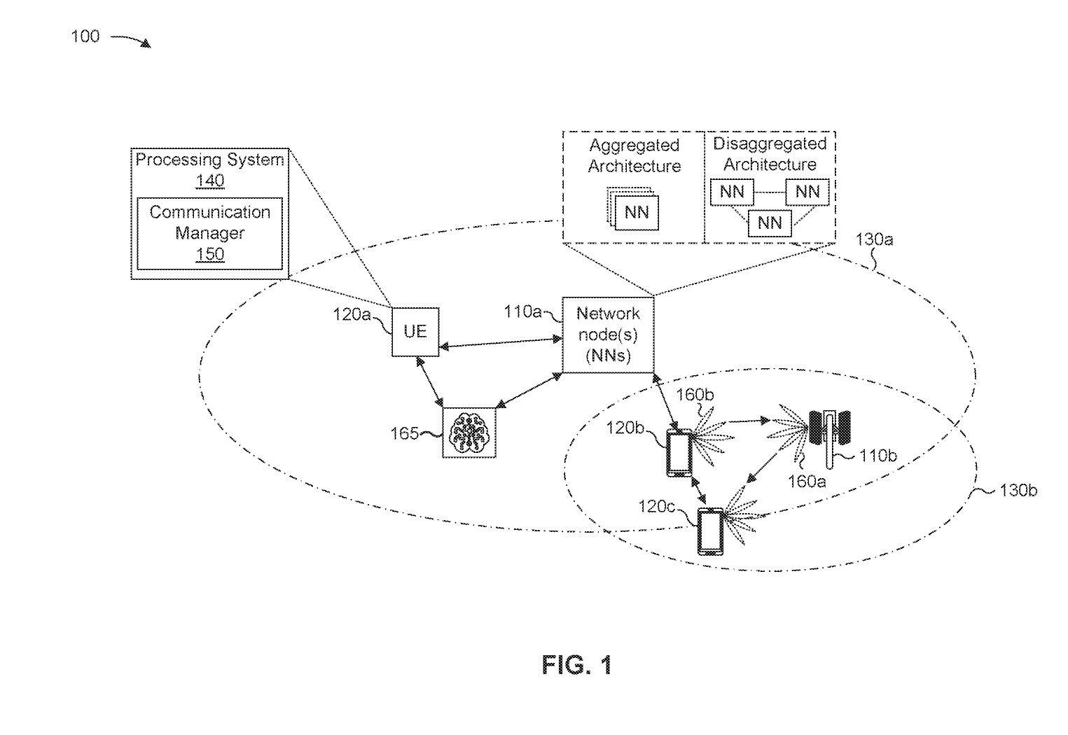

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system of the network node 110. A processing system (for example, the processing system 140) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 may include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 may include or be coupled with one or more modems (such as a cellular (for example, a 5G or 6G compliant) modem). In some examples, one or more processors of the processing system 140 include or implement one or more of the modems. The processing system 140 may also include or be coupled with multiple radios (collectively “the radio”), multiple RF chains, or multiple transceivers, each of which may in turn be coupled with one or more of multiple antennas. In some examples, one or more processors of the processing system 140 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120).

A processing system (e.g., the processing system 140) may generally be a system or a series of machines or components that receives inputs and processes the inputs to produce a set of outputs (which may be passed to other systems or components of, for example, the UE 120). For example, the processing system 140 of the UE 120 may be a system that includes the various other components or subcomponents of the UE 120.

A processing system of the network node 110 may interface with one or more other components of the network node 110, may process information received from one or more other components (such as inputs or signals), or may output information to one or more other components. For example, a chip or modem of the network node 110 may include the processing system, a first interface to receive or obtain information, and a second interface to output, transmit, or provide information. In some examples, the first interface may be an interface between the processing system of the chip or modem and a receiver, such that the network node 110 may receive information or signal inputs, and the information may be passed to the processing system. In some examples, the second interface may be an interface between the processing system of the chip or modem and a transmitter, such that the network node 110 may transmit information output from the chip or modem. Similarly, the processing system 140 of the UE 120 may interface with one or more other components of the UE 120, may process information received from one or more other components (such as inputs or signals), or may output information to one or more other components. For example, a chip or modem of the UE 120 may include the processing system 140, a first interface to receive or obtain information, and a second interface to output, transmit, or provide information. In some examples, the first interface may be an interface between the processing system 140 of the chip or modem and a receiver, such that the UE 120 may receive information or signal inputs, and the information may be passed to the processing system 140. In some examples, the second interface may be an interface between the processing system 140 of the chip or modem and a transmitter, such that the UE 120 may transmit information output from the chip or modem. A person having ordinary skill in the art will readily recognize that the second interface described above also may obtain or receive information or signal inputs, and the first interface described above may also may output, transmit, or provide information.

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

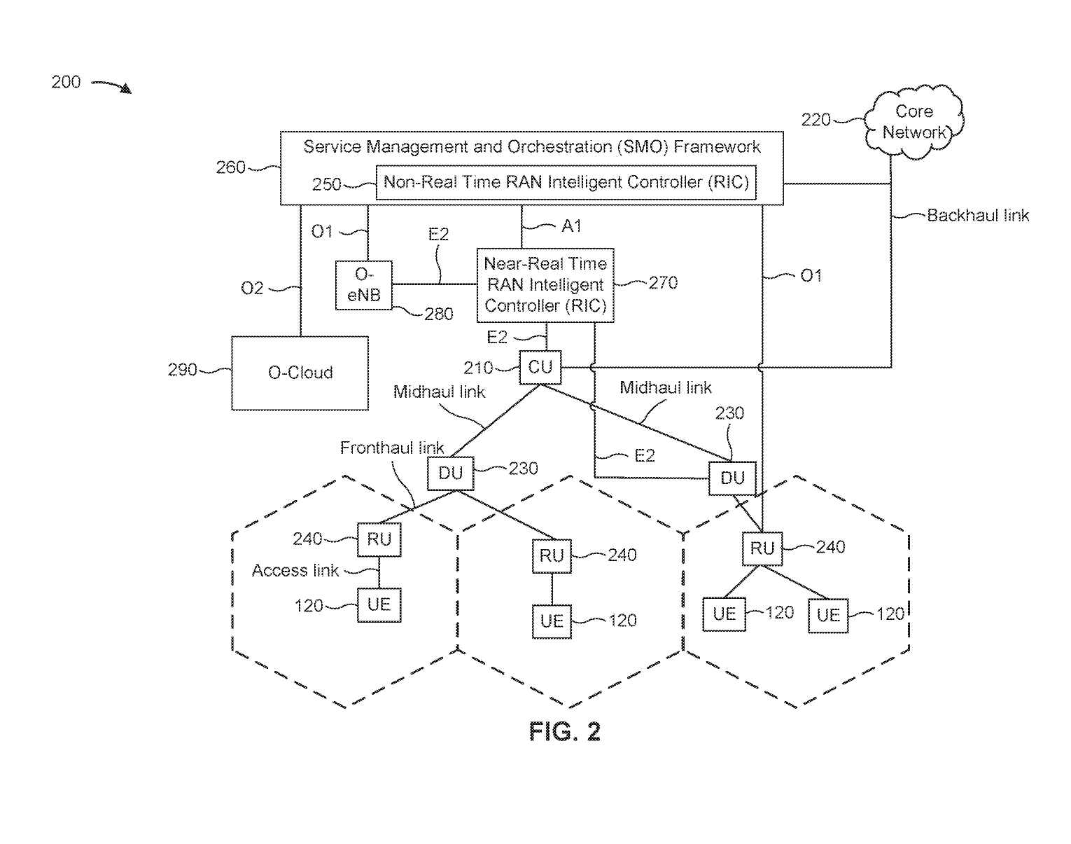

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)- reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 140) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 140 and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 140 and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 140 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 140 and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 140 and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110, one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

A network node 110 or a UE 120 operating in a half-duplex mode may perform only one of transmission or reception during particular time resources, such as during particular slots, symbols, or other time periods. In various examples, some of the network nodes 110 and the UEs 120 of the wireless communication network 100 may be configured for full-duplex operation in addition to half-duplex operation. In full-duplex operation, a network node 110 or a UE 120 operating in a full-duplex (for example, SBFD) mode can transmit and receive communications concurrently (for example, in the same time resources). For example, as shown in FIG. 1, the network node 110b may operate in the full-duplex mode. The network node 110b may concurrently receive uplink communications from the UE 120b and transmit downlink communications to the UE 120c. By operating in a full-duplex mode, network nodes 110 and/or UEs 120 may generally increase the capacity of the network and the radio access link. In some examples, full-duplex operation may involve FDD, in which downlink transmissions of the network node 110b are performed in a first frequency band or on a first component carrier and transmissions of the UE 120b are performed in a second frequency band or on a second component carrier different than the first frequency band or the first component carrier, respectively. In some examples, full-duplex operation may be enabled for a UE 120 but not for a network node 110. For example, a UE 120 may simultaneously transmit an uplink transmission to a first network node 110 and receive a downlink transmission from a second network node 110 in the same time resources. In some other examples, full-duplex operation may be enabled for a network node 110 but not for a UE 120. For example, the network node 110b may simultaneously transmit a downlink transmission to a first UE 120 (for example, the UE 120c) and receive an uplink transmission from a second UE 120 (for example, the UE 120b) in the same time resources. In some other examples, full-duplex operation may be enabled for both a network node 110 and a UE 120.

In some aspects, the UE 120 may include a communication manager 150. As described in more detail elsewhere herein, the communication manager 150 may receive a configuration for SBFD resources in at least a first TDD pattern, transmit an uplink communication in an SBFD slot in accordance with the SBFD resources, and receive a downlink communication in the SBFD slot in accordance with the SBFD resources. Additionally or alternatively, the communication manager 150 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

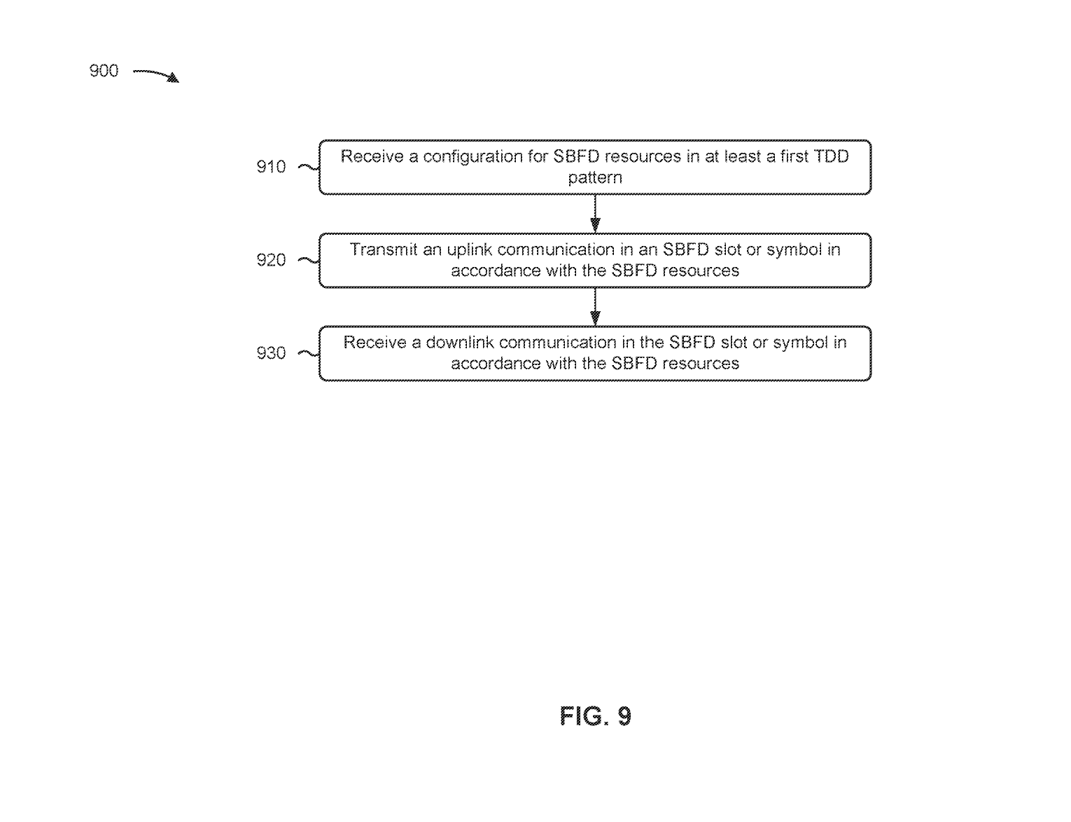

The network node 110, the UE 120, the processing system 140 of the UE 120, the CU 210, the DU 230, the RU 240, or any other component(s) of FIG. 1 and/or FIG. 2 may implement one or more techniques or perform one or more operations associated with SBFD communication by an SBFD-capable UE, as described in more detail elsewhere herein. For example, the processing system 140 of the UE 120, the CU 210, the DU 230, or the RU 240 may perform or direct operations of, for example, process 900 of FIG. 9, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors of the network node 110, the UE 120 (for example, the processing system 140 of the UE 120), the CU 210, the DU 230, or the RU 240, may cause the one or more processors to perform process 900 of FIG. 9, or other processes as described herein. In some examples, executing instructions may include running the instructions, converting the instructions, compiling the instructions, and/or interpreting the instructions, among other examples.

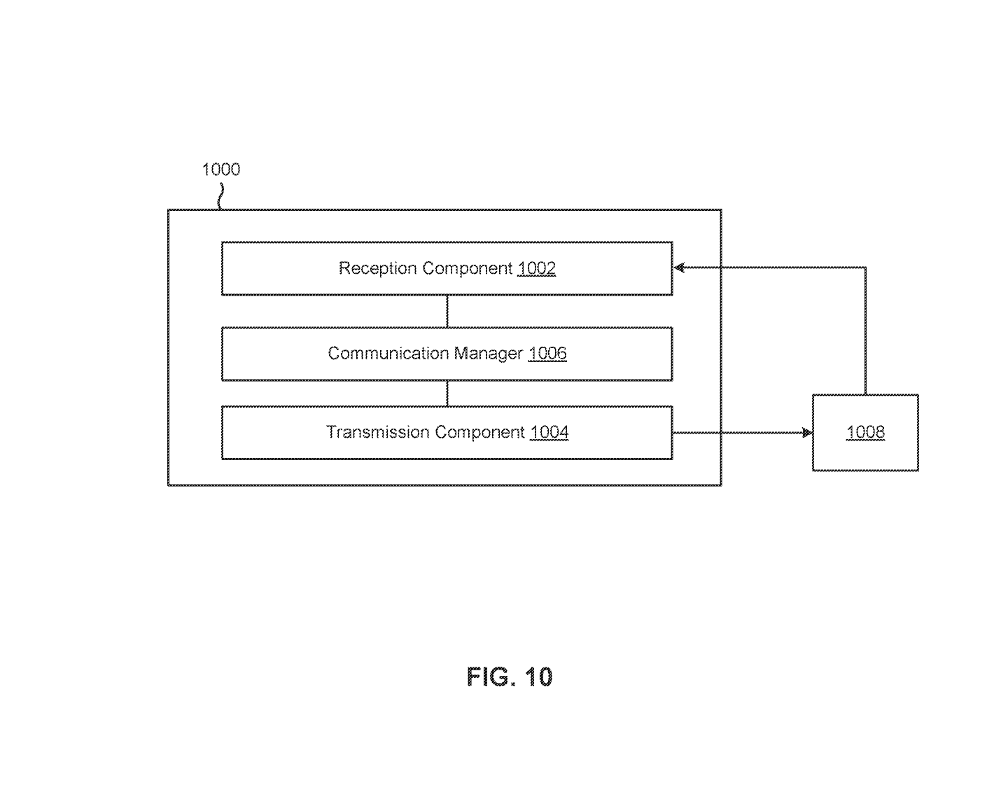

In some aspects, the UE 120 may include means for receiving a configuration for SBFD resources in at least a first TDD pattern; means for transmitting an uplink communication in an SBFD slot in accordance with the SBFD resources; and/or means for receiving a downlink communication in the SBFD slot in accordance with the SBFD resources. The means for the UE 120 to perform operations described herein may include, for example, one or more of communication manager 150, processing system 140, a radio, one or more RF chains, one or more transceivers, one or more antennas, one or more modems, a reception component (for example, reception component 1002 depicted and described in connection with FIG. 10), and/or a transmission component (for example, transmission component 1004 depicted and described in connection with FIG. 10), among other examples.

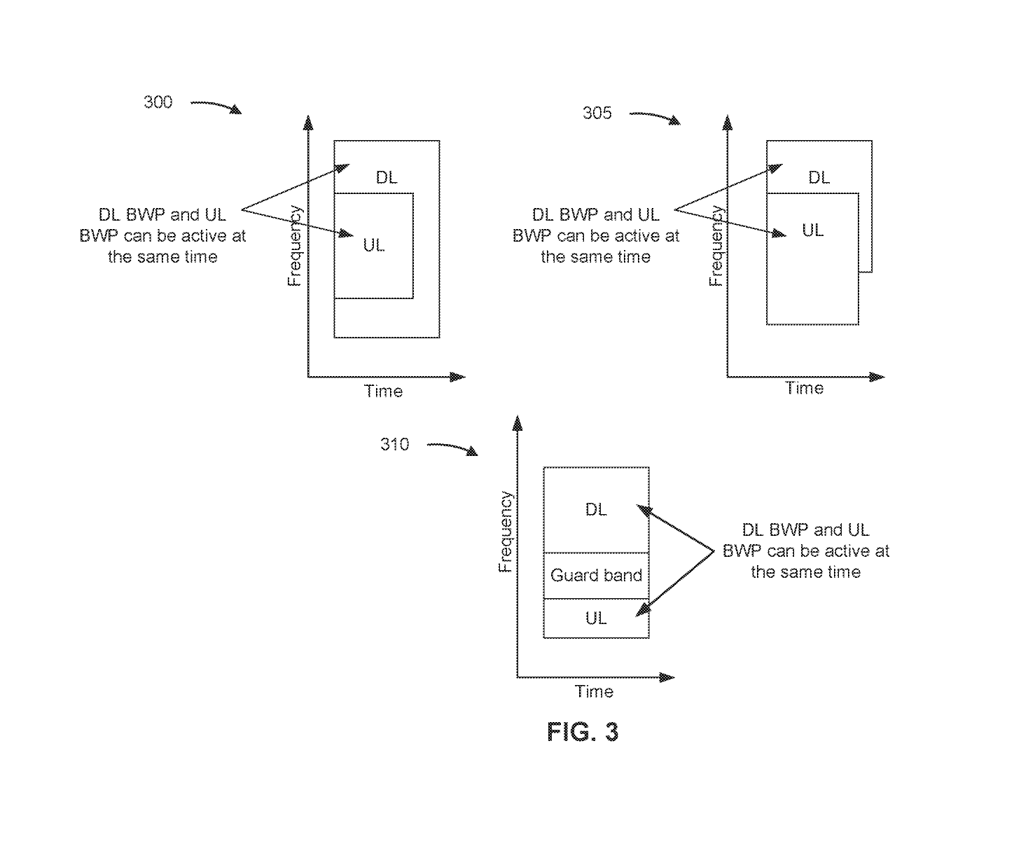

FIG. 3 is a diagram illustrating examples 300, 305, and 310 of full-duplex communication in a wireless network, in accordance with the present disclosure. “Full-duplex communication” in a wireless network refers to simultaneous bi-directional communication between devices in the wireless network. For example, a UE operating in a full-duplex mode may transmit an uplink communication and receive a downlink communication at the same time (e.g., in the same slot or the same symbol). “Half-duplex communication” in a wireless network refers to unidirectional communications (e.g., only downlink communication or only uplink communication) between devices at a given time (e.g., in a given slot or a given symbol).

As shown in FIG. 3, examples 300 and 305 show examples of in-band full-duplex (IBFD) communication. In IBFD, a UE may transmit an uplink communication to a network node and receive a downlink communication from the network node on the same time and frequency resources. As shown in example 300, in a first example of IBFD, the time and frequency resources for uplink communication may fully overlap with the time and frequency resources for downlink communication. As shown in example 305, in a second example of IBFD, the time and frequency resources for uplink communication may partially overlap with the time and frequency resources for downlink communication.

As further shown in FIG. 3, example 310 shows an example of SBFD communication, which may also be referred to as “sub-band frequency division duplex (SBFDD)” or “flexible duplex.” In SBFD, a UE may transmit an uplink communication to a network node and receive a downlink communication from the network node at the same time, but on different frequency resources. For example, the different frequency resources may be sub-bands of a frequency band, such as a time division duplexing band. In this case, the frequency resources used for downlink communication may be separated from the frequency resources used for uplink communication, in the frequency domain, by a guard band.

As indicated above, FIG. 3 is provided as an example. Other examples may differ from what is described with respect to FIG. 3.

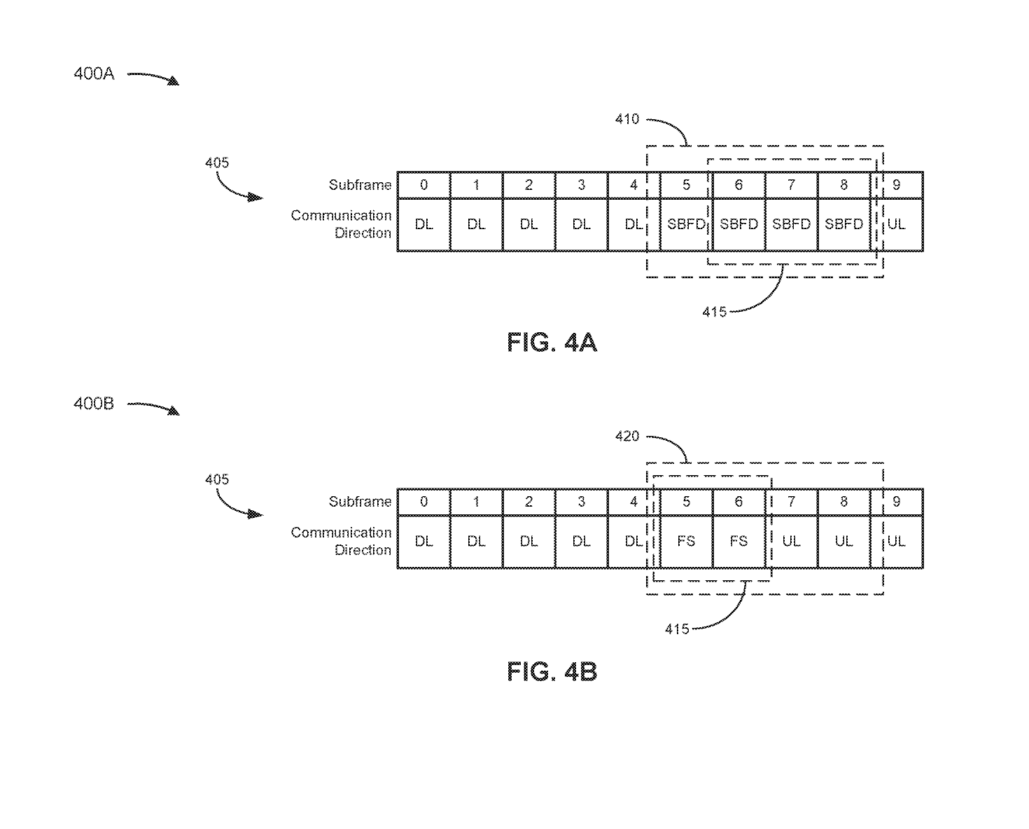

FIGS. 4A and 4B are diagrams illustrating examples 400A and 400B associated with a configuration for TDD pattern for an SBFD-capable UE, in accordance with the present disclosure. As shown in FIGS. 4A and 4B, example 400 includes a TDD pattern 405 for communication between a network node (e.g., network node 110) and a UE (e.g., UE 120). In some aspects, the network node and the UE may be included in a wireless network, such as wireless network 100.

With respect to FIG. 4A, in some aspects, the network node may configure one or more UEs with a TDD pattern 405. The configuration for the TDD pattern 405 may allocate one or more resources (e.g., slots or subframes, among other examples) for downlink communications, allocate one or more resources for SBFD communications 410, and/or allocate one or more resources for uplink communications. In the example 400 of FIG. 4, the configuration for the TDD pattern 405 may allocate subframes 0-4 for downlink communications, subframes 5-8 for SBFD communications 410, and subframe 9 for uplink communications.

In some aspects, the resources for SBFD communications 410 may be explicitly allocated by the network node. When the resources are explicitly allocated by the network node, the network node may simultaneously transmit and receive communications from one or more UEs. The network node may indicate which resources are allocated for SBFD communications 410 so that the UEs transmitting during the resources for SBFD communications 410 may perform one or more cross-link interference (CLI) processes to reduce interference caused by the transmission and/or reception of communications between the network node and one or more UEs. In some aspects, for the resources for SBFD communications 410, the network node may perform one or more self-interference mitigation processes to reduce interference caused by signals transmitted from and/or received by the network node. In some aspects, for SBFD-capable UEs, the network node may configure at least a subset of the resources for SBFD communications 410 as SBFD-UE resources 415. The SBFD-UE resources 415 may include resources in which one or more SBFD-capable UEs can communicate, with the network node, in a full-duplex mode. Accordingly, in accordance with the SBFD-UE resources 415 configured by the network node, the UE may transmit uplink communications to the network node while simultaneously receiving downlink communications from the network node. In some aspects, the resources for SBFD communications 410 and the SBFD-UE resources 415 may be the same resources.

In some aspects, the network node may not explicitly configure SBFD resources in the TDD pattern. For example, with reference to FIG. 4B, the network node may configure the TDD pattern 405 with resources (e.g., subframes or slots, among other examples) for downlink communications, resources for flexible slots, and/or resources for uplink communications. In some aspects, the configuration for the TDD pattern 405 may indicate or configure one or more UEs with a default SBFD window 420. The default SBFD window 420 may be associated with resources in which a network node typically or historically has operated in an SBFD mode (or other full duplex mode) with one or more UEs. In some aspects, the network node may configure one or more UEs, such as one or more SBFD-capable UEs, with SBFD-UE resources 415. In some aspects, the SBFD-UE resources 415 may be at least a subset of the resources associated with the default SBFD window 420. In some aspects, the resources associated with the default SBFD window 420 may be the same as the SBFD-UE resources 415 in the TDD pattern 405.

In some aspects, with respect to both FIGS. 4A and 4B, the one or more UEs in communication with the network node may be configured to repeat the configured TDD pattern 405 for communications with the network node. For example, the one or more UEs in communication with the network node may follow the same resource allocations as indicated by the TDD pattern 405 while communicating with the network node or until the network node configures the one or more UEs with a different TDD pattern.

As indicated above, FIGS. 4A and 4B are provided as an example. Other examples may differ from what is described with respect to FIGS. 4A and 4B.

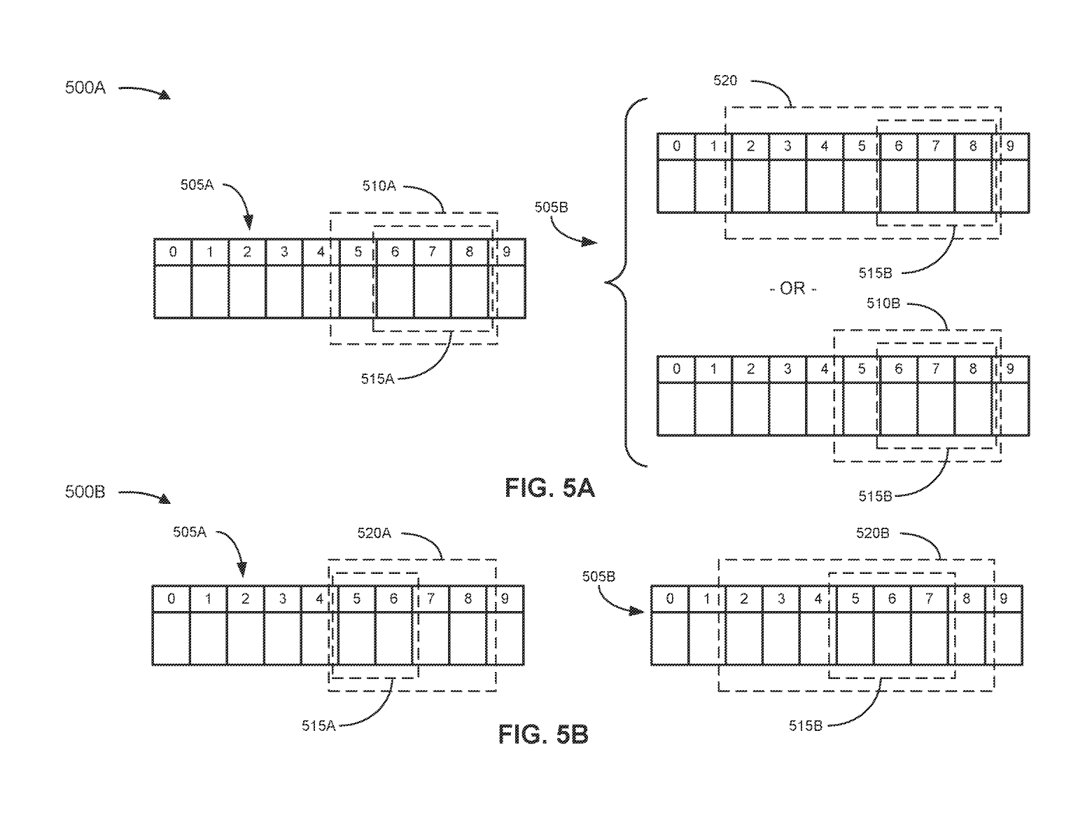

FIGS. 5A and 5B are diagrams illustrating examples 500A and 500B associated with a configuration for multiple TDD patterns for an SBFD-capable UE, in accordance with the present disclosure. As shown in FIGS. 5A and 5B, examples 500A and 500B, respectively, include communication between a network node (e.g., network node 110) and a UE (e.g., UE 120) represented as TDD patterns 505. In some aspects, the network node and UE may be included in a wireless network, such as wireless network 100.

With reference to FIG. 5A, in some aspects, the network node may configure the UE with a first TDD pattern 505A and a second TDD pattern 505B. In some aspects, the first TDD pattern 505A and the second TDD pattern 505B may be configured with one or more resources for SBFD communication 510. In some aspects, the first TDD pattern 505A may be configured with a first set of resources for SBFD communication 510A and the second TDD pattern 505B may be configured with a second set of resources for SBFD communication 510B. Alternatively, in some aspects, the second TDD pattern 505B may not be configured with the second set of resources for SBFD communication 510B. When the second TDD pattern 505B is not configured with the second set of resources for SBFD communication 510B, the UE may be configured to identify a default SBFD window 520.

In some aspects, the first TDD pattern 505A and the second TDD pattern 505B may be configured with one or more SBFD-UE resources 515. For example, in some aspects, the SBFD-UE resources 515A may be configured as a subset of the first set of resources for SBFD communication 510A. In some aspects, the SBFD-UE resources 515B may be configured as a subset of the second set of resources for SBFD communication 510B. In some aspects, the SBFD-UE resources 515B may be configured as a subset of the resources included in the default SBFD window 520.

In some aspects, the second TDD pattern 505B may be different from the first TDD pattern 505A. For example, in some aspects, the resources for SBFD communication 510B of the second TDD pattern 505B may be different from the resources for SBFD communication 510A in the first TDD pattern 505A. Additionally, in some aspects, the SBFD-UE resources 515A of the first TDD pattern 505A may be different from the SBFD-UE resources 515B of the second TDD pattern 505B. Alternatively, in some aspects, the SBFD-UE resources 515A of the first TDD pattern 505A may be the same as the SBFD-UE resources 515B of the second TDD pattern 505B.

In some aspects, the second TDD pattern 505B may be identical to the first TDD pattern 505A. Accordingly, the resources for SBFD communication 510A in the first TDD pattern 505A may be the same as the resources for SBFD communication 510B in the second TDD pattern 505B. Additionally, in some aspects, the SBFD-UE resources 515B of the second TDD pattern 505B may be the same resources as the SBFD-UE resources 515A of the first TDD pattern 505A.

With reference to FIG. 5B, in some aspects, the network node may not configure the TDD pattern 505 with one or more resources for SBFD communication 510. Rather, in some aspects, the UE may be configured to identify, or the network node may be configured to indicate, a first default SBFD window 520A in the first TDD pattern 505A. In some aspects, the first default SBFD window 520A may include a subset of resources of the first TDD pattern 505A. In some aspects, the network node may configure the first TDD pattern 505A to include one or more SBFD-UE resources 515A. In some aspects, the one or more SBFD-UE resources 515A of the first TDD pattern 505A may be a subset of the first default SBFD window 520A.

In some aspects, the network node may further configure a second TDD pattern 505B, which may include a second default SBFD window 520B. In some aspects, the second default SBFD window 520B may include the same set of resources as the first default SBFD window 520A. Alternatively, in some aspects, the second default SBFD window 520B may include a different set of resources than the first default SBFD window 520A. In some aspects, the second default SBFD window 520B may include SBFD-UE resources 515B, which may be the same as or different than the SBFD-UE resources 515A in the first TDD pattern 505A.

Accordingly, in some aspects, the UE may be configured with two TDD patterns (e.g., the first TDD pattern 505A and the second TDD pattern 505B). The two TDD patterns 505 may be identical to or different from one another. Additionally, the TDD patterns 505 may include resources explicitly indicated or configured for SBFD communication (e.g., resources for SBFD communication n510A and/or resources for SBFD communication 510B) or with a default SBFD window (e.g., default SBFD window 520) indicating a set of resources typically or historically associated with SBFD communication. In some aspects, the SBFD-UE resources (e.g., SBFD-UE resources 515) may be a subset of the indicated or configured resources for SBFD communication. Alternatively, in some aspects, the SBFD-UE resources (e.g., SBFD-UE resources 515) may be a subset of the resources in the default SBFD window.

As indicated above, FIGS. 5A and 5B are provided as an example. Other examples may differ from what is described with respect to FIGS. 5A and 5B.

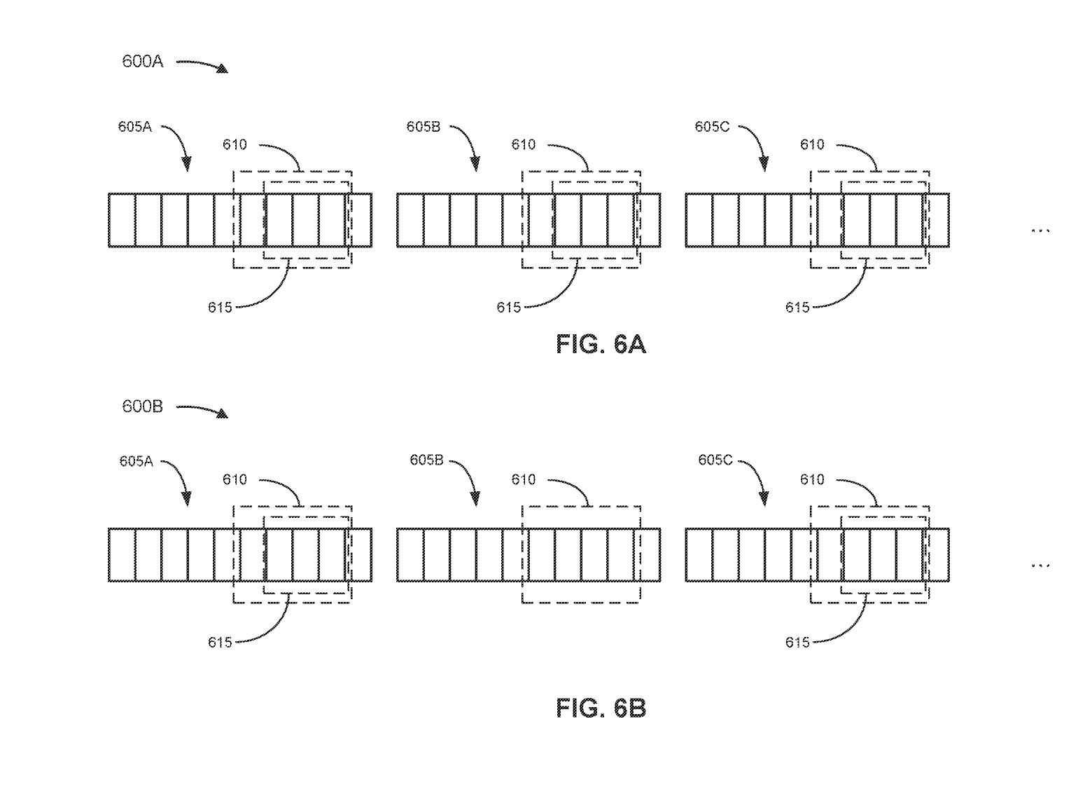

FIGS. 6A and 6B are diagrams illustrating examples 600A and 600B associated with a periodicity of SBFD-UE resources, in accordance with the present disclosure. As shown in FIGS. 6A and 6B, examples 600A and 600B include communication between a network node (e.g., network node 110) and a UE (e.g., UE 120) in accordance with a TDD pattern 605. In some aspects, the network node and UE may be included in a wireless network, such as wireless network 100.

With reference to FIG. 6A, a first TDD pattern 405A may be configured with a set of resources for SBFD communication 610A. In some aspects, a second TDD pattern 405B may be configured with a set of resources for SBFD communication 610B. Additionally, in some aspects, a third TDD pattern 405C may be configured with a set of resources for SBFD communication 610C. In some aspects, the first TDD pattern 405A may be further configured with SBFD-UE resources 615. In some aspects, in the first TDD pattern 605A, the SBFD-UE resources 615 may be a subset of the set of resources for SBFD communication 610A. In some aspects, the SBFD-UE resources 615 may be configured in accordance with a periodicity. In some aspects, the periodicity may cause the SBFD-UE resources 615 to repeat in each TDD pattern 605. For example, in some aspects, the periodicity may cause the SBFD-UE resources 615 to occur during the second TDD pattern 605B and the third TDD pattern 605C, among other examples. In some aspects, the periodicity may cause the SBFD-UE resources 615 to repeat in accordance with the set of resources for SBFD communication 610 in each of the TDD patterns 605.

With reference to FIG. 6B, rather than have the SBFD-UE resources 615 occur in every set of resources for SBFD communication 610, in some aspects, the periodicity of the SBFD-UE resources 615 may be semi-statically indicated. For example, as shown in the example 600B of FIG. 6B, the periodicity of the SBFD-UE resources 615 may be semi-statically indicated to cause the SBFD-UE resources 615 to occur in every other TDD pattern 605. For example, in accordance with the periodicity being semi-statically indicated, the SBFD-UE resources 615 may be configured or indicated for the set of resources for SBFD communication 610A in a first TDD pattern 605A and in a set of resources for SBFD communication 610C in a third TDD pattern 605C. The SBFD-UE resources 615 may not be configured to occur in a set of resources for SBFD communication 610B in a second TDD pattern 605B.

As indicated above, FIGS. 6A and 6B are provided as an example. Other examples may differ from what is described with respect to FIGS. 6A and 6B.

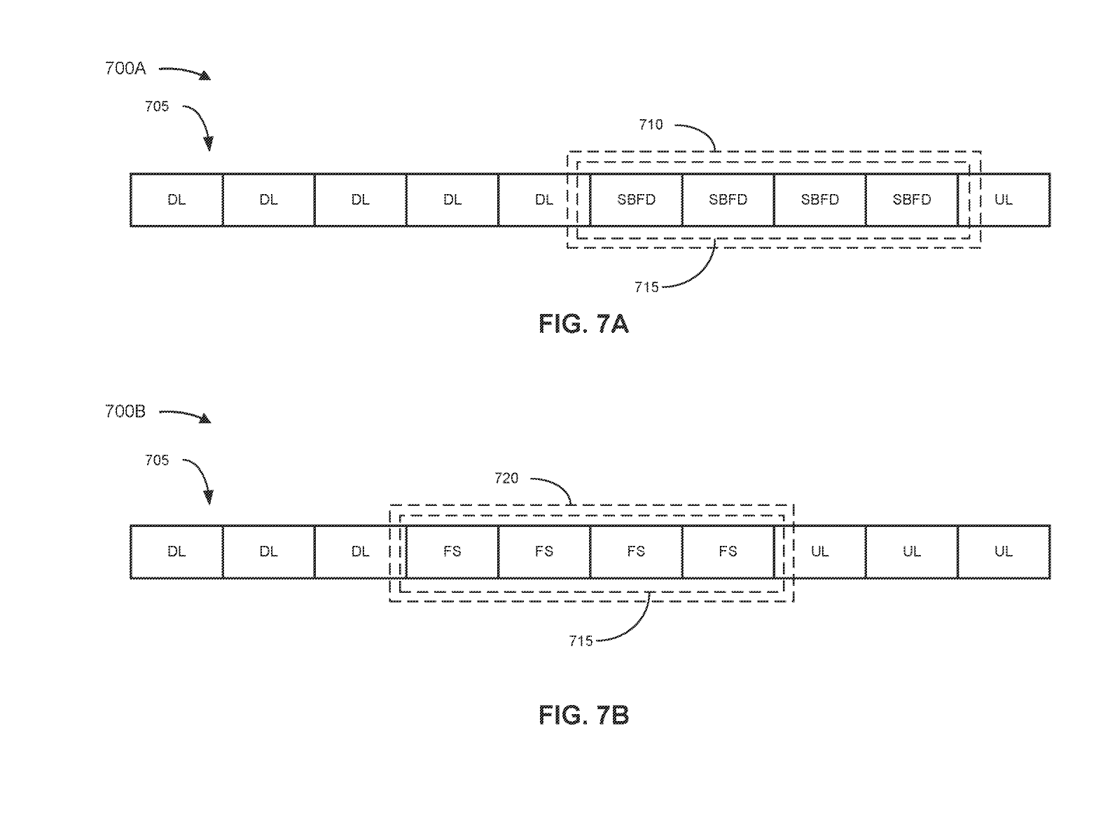

FIGS. 7A and 7B are diagrams illustrating examples 700A and 700B associated with identifying SBFD-UE resources, in accordance with the present disclosure. As shown in FIGS. 7A and 7B, examples 700A and 700B include communication between a network node (e.g., network node 110) and a UE (e.g., UE 120) in accordance with a TDD pattern 705. In some aspects, the network node and the UE may be included in a wireless network, such as wireless network 100.

With reference to FIG. 7A, the TDD pattern 705 may include a set of resources for SBFD communication 710. If the network node does not explicitly configure or indicate SBFD-UE resources 715, the UE may be configured to determine that any one or more of the resources, in the set of resources for SBFD communication 710, are available as SBFD-UE resources 715. Accordingly, in some aspects, the UE may be configured to determine that all of the resources for SBFD communication 710 are also SBFD-UE resources 715. Alternatively, in some aspects, the UE may be configured to determine that a subset (e.g., fewer than all) of the resources for SBFD communication 710 are SBFD-UE resources 715.

With reference to FIG. 7B, the TDD pattern 705 may not include a set of resources for SBFD communication 710 configured or indicated by the network node. Further, in some aspects, the network node may not explicitly configure or indicate the SBFD-UE resources 715. Accordingly, in some aspects, the UE may be configured to determine that any one or more resources associated with a default SBFD window 720 are available as SBFD-UE resources 715. Accordingly, in some aspects, the UE may be configured to determine that all of the resources in the default SBFD window 720 are also SBFD-UE resources 715. Alternatively, in some aspects, the UE may be configured to determine that a subset (e.g., fewer than all) of the resources in the default SBFD window 720 are SBFD-UE resources 715.

As indicated above, FIGS. 7A and 7B are provided as an example. Other examples may differ from what is described with respect to FIGS. 7A and 7B.

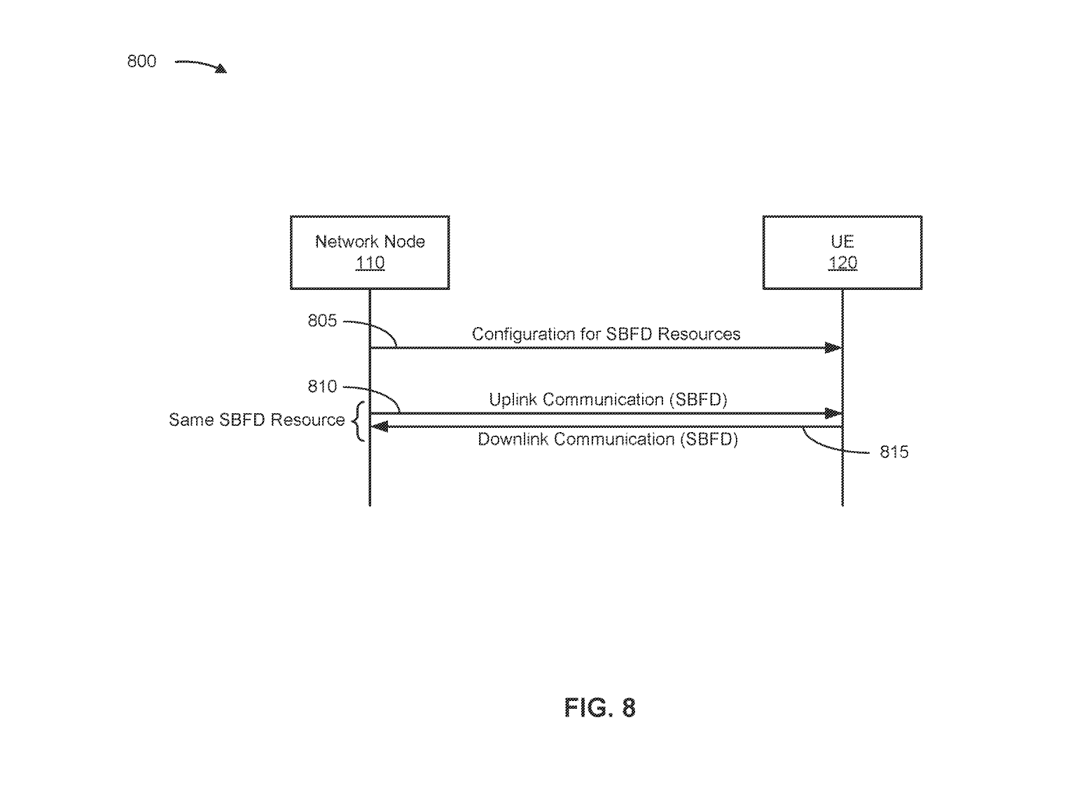

FIG. 8 is a diagram illustrating an example 800 associated with configuring an SBFD-capable UE with a TDD pattern with SBFD-UE resources, in accordance with the present disclosure. As shown in FIG. 8, a network node 110 and a UE 120 may communicate with one another.

As shown by reference number 805, the UE 120 may receive, and the network node 110 may transmit, a configuration for SBFD resources. In some aspects, the configuration for SBFD resources may configure or indicate one or more SBFD resources in at least a first TDD pattern. In some aspects, the SBFD resources in the first TDD pattern may be allocated in accordance with one or more legacy SBFD symbols allocated in the first TDD pattern. The legacy SBFD symbols may be associated with symbols in which the network node 110 operates in a full duplex mode. Alternatively, in some aspects, the SBFD resources in the first TDD pattern may be allocated in accordance with one or more default SBFD symbols.

In some aspects, the configuration for SBFD resources may further configure or indicate one or more SBFD resources in a second TDD pattern. Alternatively, in some aspects, the configuration for the SBFD resources may allocate SBFD resources in the first TDD pattern and only non-SBFD resources in the second TDD pattern. In some aspects, the SBFD resources may include one or more SBFD slots, one or more SBFD subframes, one or more SBFD symbols, and/or a combination thereof, among other examples. In some aspects, the SBFD resources may include SBFD symbols in downlink symbols, flexible symbols, and/or a combination thereof, among other examples, in the first TDD pattern.

In some aspects, the configuration for the SBFD resources may define, in the first TDD pattern and in the second TDD pattern, an SBFD pattern (e.g., a set of resources for SBFD communication) that allocates the SBFD resources. In some aspects, the configuration for the SBFD resources may allocate, in the first TDD pattern, a first SBFD pattern that allocates a first set of the SBFD resources as, for example, SBFD-UE resources. In some aspects, the configuration for SBFD resources may also or alternatively allocate, in the second TDD pattern, a second SBFD pattern that allocates a second set of the SBFD resources as, for example, SBFD-UE resources.

In some aspects, the configuration for the SBFD resources may define the first TDD pattern and the second TDD pattern. In some aspects, the SBFD resources may be allocated in the first TDD pattern in accordance with the configuration for SBFD resources. Additionally, in some aspects, the SBFD resources may be allocated in the second TDD pattern in accordance with a default SBFD window. In some aspects, the default SBFD window may be based, at least in part, on the SBFD resources allocated in the first TDD pattern.

In some aspects, the configuration for the SBFD resources may configure the SBFD resources in the first TDD pattern and/or in the second TDD pattern in accordance with one or more periodicities. In some aspects, at least one of the one or more periodicities may be semi-statically configured.

As shown by reference number 810, the UE 120 may transmit, and the network node 110 may receive, an uplink communication in an SBFD slot or subframe in accordance with the SBFD resources. In some aspects, the SBFD resources may be allocated in accordance with the configuration for SBFD resources, as discussed above.

As shown by reference number 815, the UE 120 may receive, and the network node 110 may transmit, a downlink communication in the SBFD slot or subframe. In some aspects, the network node 110 may transmit the downlink communication in the same slot or subframe as the slot or subframe used by the UE 120 to transmit the uplink communication. In some aspects, the network node 110 may transmit, and the UE 120 may receive, the downlink communication in the SBFD slot or subframe in accordance with the SBFD resources. For example, the UE 120 may receive the downlink communication in the SBFD slot or subframe indicated as an SBFD-UE resource.

As indicated above, FIG. 8 is provided as an example. Other examples may differ from what is described with respect to FIG. 8.

FIG. 9 is a diagram illustrating an example process 900 performed, for example, at a UE or an apparatus of a UE, in accordance with the present disclosure. Example process 900 is an example where the apparatus or the UE (e.g., UE 120) performs operations associated with TDD patterns for SBFD-capable UEs.

As shown in FIG. 9, in some aspects, process 900 may include receiving a configuration for SBFD resources in at least a first TDD pattern (block 910). For example, the UE (e.g., using reception component 1002 and/or communication manager 1006, depicted in FIG. 10) may receive a configuration for SBFD resources in at least a first TDD pattern, as described above.

As further shown in FIG. 9, in some aspects, process 900 may include transmitting an uplink communication in an SBFD slot or symbol in accordance with the SBFD resources (block 920). For example, the UE (e.g., using transmission component 1004 and/or communication manager 1006, depicted in FIG. 10) may transmit an uplink communication in an SBFD slot or symbol in accordance with the SBFD resources, as described above.

As further shown in FIG. 9, in some aspects, process 900 may include receiving a downlink communication in the SBFD slot or symbol in accordance with the SBFD resources (block 930). For example, the UE (e.g., using reception component 1002 and/or communication manager 1006, depicted in FIG. 10) may receive a downlink communication in the SBFD slot or symbol in accordance with the SBFD resources, as described above.

Process 900 may include additional aspects, such as any single aspect or any combination of aspects described below and/or in connection with one or more other processes described elsewhere herein.

In a first aspect, the configuration for the SBFD resources allocates the SBFD resources in the first TDD pattern and in a second TDD pattern.

In a second aspect, alone or in combination with the first aspect, the configuration for the SBFD resources allocates the SBFD resources in the first TDD pattern and allocates non-SBFD resources in a second TDD pattern.

In a third aspect, alone or in combination with one or more of the first and second aspects, the SBFD slot or symbol includes one or more of downlink symbols or flexible symbols of the first TDD pattern.

In a fourth aspect, alone or in combination with one or more of the first through third aspects, the configuration defines, in the first TDD pattern and a second TDD pattern, an SBFD pattern that allocates the SBFD resources.

In a fifth aspect, alone or in combination with one or more of the first through fourth aspects, the configuration defines, in the first TDD pattern, a first SBFD pattern that allocates a first set of the SBFD resources.

In a sixth aspect, alone or in combination with one or more of the first through fifth aspects, the configuration defines, in a second TDD pattern, a second SBFD pattern that allocates a second set of the SBFD resources.

In a seventh aspect, alone or in combination with one or more of the first through sixth aspects, the configuration defines the first TDD pattern and a second TDD pattern, and the SBFD resources are allocated only in the first TDD pattern.

In an eighth aspect, alone or in combination with one or more of the first through seventh aspects, the configuration defines the first TDD pattern and a second TDD pattern, wherein the SBFD resources are allocated in the first TDD pattern in accordance with the configuration, and wherein the SBFD resources are allocated in the second TDD pattern in accordance with a default SBFD window.

In a ninth aspect, alone or in combination with one or more of the first through eighth aspects, the default SBFD window is based, at least in part, on the SBFD resources allocated in the first TDD pattern.

In a tenth aspect, alone or in combination with one or more of the first through ninth aspects, the configuration allocates the SBFD resources in at least one of the first TDD pattern and a second TDD pattern in accordance with one or more periodicities.

In an eleventh aspect, alone or in combination with one or more of the first through tenth aspects, at least one of the one or more periodicities are semi-statically configured.

In a twelfth aspect, alone or in combination with one or more of the first through eleventh aspects, the SBFD resources in the first TDD pattern are allocated in accordance with one or more legacy SBFD symbols allocated in the first TDD pattern.

In a thirteenth aspect, alone or in combination with one or more of the first through twelfth aspects, the SBFD resources in the first TDD pattern are allocated in accordance with one or more default SBFD symbols.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 150 described in connection with FIG. 1. As shown, the apparatus 1000 may communicate with another apparatus 1008, such as a UE or a network node (such as a CU, a DU, an RU, or a base station), using the reception component 1002 and the transmission component 1004. The communication manager 1006 may be included in, or implemented via, a processing system (for example, the processing system 140 described in connection with FIG. 1) of the UE.

In some aspects, the apparatus 1000 may be configured to perform one or more operations described herein in connection with FIGS. 4-8. Additionally, or alternatively, the apparatus 1000 may be configured to perform one or more processes described herein, such as process 900 of FIG. 9. In some aspects, the apparatus 1000 and/or one or more components shown in FIG. 10 may include one or more components of the UE described in connection with FIG. 1. Additionally, or alternatively, one or more components shown in FIG. 10 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications, and may provide the processed signals to the one or more other components of the apparatus 1000. In some aspects, the reception component 1002 may include one or more components of the UE described above in connection with FIG. 1, such as a radio, one or more RF chains, one or more transceivers, or one or more modems, each of which may in turn be coupled with one or more antennas of the UE.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications, and may transmit the processed signals to the apparatus 1008. In some aspects, the transmission component 1004 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1004 may be co-located with the reception component 1002.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive a configuration for SBFD resources in at least a first TDD pattern. The transmission component 1004 may transmit an uplink communication in an SBFD slot or symbol in accordance with the SBFD resources. The reception component 1002 may receive a downlink communication in the SBFD slot or symbol in accordance with the SBFD resources.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: receiving a configuration for SBFD resources in at least a first TDD pattern; transmitting an uplink communication in an SBFD slot or symbol in accordance with the SBFD resources; and receiving a downlink communication in the SBFD slot or symbol in accordance with the SBFD resources.

Aspect 2: The method of Aspect 1, wherein the configuration for the SBFD resources allocates the SBFD resources in the first TDD pattern and in a second TDD pattern.

Aspect 3: The method of any of Aspects 1-2, wherein the configuration for the SBFD resources allocates the SBFD resources in the first TDD pattern and allocates non-SBFD resources in a second TDD pattern.

Aspect 4: The method of any of Aspects 1-3, wherein the SBFD slot or symbol includes one or more of downlink symbols or flexible symbols of the first TDD pattern.

Aspect 5: The method of any of Aspects 1-4, wherein the configuration defines, in the first TDD pattern and a second TDD pattern, an SBFD pattern that allocates the SBFD resources.

Aspect 6: The method of any of Aspects 1-5, wherein the configuration defines, in the first TDD pattern, a first SBFD pattern that allocates a first set of the SBFD resources.

Aspect 7: The method of Aspect 6, wherein the configuration defines, in a second TDD pattern, a second SBFD pattern that allocates a second set of the SBFD resources.

Aspect 8: The method of any of Aspects 1-7, wherein the configuration defines the first TDD pattern and a second TDD pattern, and wherein the SBFD resources are allocated only in the first TDD pattern.

Aspect 9: The method of any of Aspects 1-8, wherein the configuration defines the first TDD pattern and a second TDD pattern, wherein the SBFD resources are allocated in the first TDD pattern in accordance with the configuration, and wherein the SBFD resources are allocated in the second TDD pattern in accordance with a default SBFD window.

Aspect 10: The method of Aspect 9, wherein the default SBFD window is based, at least in part, on the SBFD resources allocated in the first TDD pattern.

Aspect 11: The method of any of Aspects 1-10, wherein the configuration allocates the SBFD resources in at least one of the first TDD pattern and a second TDD pattern in accordance with one or more periodicities.

Aspect 12: The method of Aspect 11, wherein at least one of the one or more periodicities are semi-statically configured.

Aspect 13: The method of any of Aspects 1-12, wherein the SBFD resources in the first TDD pattern are allocated in accordance with one or more legacy SBFD symbols allocated in the first TDD pattern.

Aspect 14: The method of any of Aspects 1-13, wherein the SBFD resources in the first TDD pattern are allocated in accordance with one or more default SBFD symbols.

Aspect 15: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-14.

Aspect 16: An apparatus for wireless communication at a device, the apparatus comprising one or more memories and one or more processors coupled to the one or more memories, the one or more processors configured to cause the device to perform the method of one or more of Aspects 1-14.

Aspect 17: An apparatus for wireless communication, the apparatus comprising at least one means for performing the method of one or more of Aspects 1-14.

Aspect 18: A non-transitory computer-readable medium storing code for wireless communication, the code comprising instructions executable by one or more processors to perform the method of one or more of Aspects 1-14.

Aspect 19: A non-transitory computer-readable medium storing a set of instructions for wireless communication, the set of instructions comprising one or more instructions that, when executed by one or more processors of a device, cause the device to perform the method of one or more of Aspects 1-14.

Aspect 20: A device for wireless communication, the device comprising a processing system that includes one or more processors and one or more memories coupled with the one or more processors, the processing system configured to cause the device to perform the method of one or more of Aspects 1-14.

Aspect 21: An apparatus for wireless communication at a device, the apparatus comprising one or more memories and one or more processors coupled to the one or more memories, the one or more processors individually or collectively configured to cause the device to perform the method of one or more of Aspects 1-14.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a + b, a + c, b + c, and a + b + c, as well as any combination with multiples of the same element (for example, a + a, a + a + a, a + a + b, a + a + c, a + b + b, a + c + c, b + b, b + b + b, b + b + c, c + c, and c + c + c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE) for wireless communication, comprising:
one or more memories; and
one or more processors, coupled to the one or more memories, configured to cause the UE to:
receive a configuration for sub-band full duplex (SBFD) resources in at least a first time division duplexing (TDD) pattern;
transmit an uplink communication in an SBFD slot or symbol in accordance with the SBFD resources; and
receive a downlink communication in the SBFD slot or symbol in accordance with the SBFD resources.

2. The UE of claim 1, wherein the configuration for the SBFD resources allocates the SBFD resources in the first TDD pattern and in a second TDD pattern.

3. The UE of claim 1, wherein the configuration for the SBFD resources allocates the SBFD resources in the first TDD pattern and allocates non-SBFD resources in a second TDD pattern.

4. The UE of claim 1, wherein the SBFD slot or symbol includes one or more of downlink symbols or flexible symbols of the first TDD pattern.

5. The UE of claim 1, wherein the configuration defines, in the first TDD pattern and a second TDD pattern, an SBFD pattern that allocates the SBFD resources.

6. The UE of claim 1, wherein the configuration defines, in the first TDD pattern, a first SBFD pattern that allocates a first set of the SBFD resources.

7. The UE of claim 6, wherein the configuration defines, in a second TDD pattern, a second SBFD pattern that allocates a second set of the SBFD resources.

8. The UE of claim 1, wherein the configuration defines the first TDD pattern and a second TDD pattern, and
wherein the SBFD resources are allocated only in the first TDD pattern.

9. The UE of claim 1, wherein the configuration defines the first TDD pattern and a second TDD pattern,
wherein the SBFD resources are allocated in the first TDD pattern in accordance with the configuration, and
wherein the SBFD resources are allocated in the second TDD pattern in accordance with a default SBFD window.

10. The UE of claim 9, wherein the default SBFD window is based, at least in part, on the SBFD resources allocated in the first TDD pattern.

11. The UE of claim 1, wherein the configuration allocates the SBFD resources in at least one of the first TDD pattern and a second TDD pattern in accordance with one or more periodicities.

12. The UE of claim 11, wherein at least one of the one or more periodicities are semi-statically configured.

13. The UE of claim 1, wherein the SBFD resources in the first TDD pattern are allocated in accordance with one or more legacy SBFD symbols allocated in the first TDD pattern.

14. The UE of claim 1, wherein the SBFD resources in the first TDD pattern are allocated in accordance with one or more default SBFD symbols.

15. A method of wireless communication performed by a user equipment (UE), comprising:
receiving a configuration for sub-band full duplex (SBFD) resources in at least a first time division duplexing (TDD) pattern;
transmitting an uplink communication in an SBFD slot or symbol in accordance with the SBFD resources; and
receiving a downlink communication in the SBFD slot or symbol in accordance with the SBFD resources.

16. The method of claim 15, wherein the configuration for the SBFD resources allocates the SBFD resources in the first TDD pattern and in a second TDD pattern.

17. The method of claim 15, wherein the configuration for the SBFD resources allocates the SBFD resources in the first TDD pattern and allocates non-SBFD resources in a second TDD pattern.

18. The method of claim 15, wherein the configuration defines the first TDD pattern and a second TDD pattern,
wherein the SBFD resources are allocated in the first TDD pattern in accordance with the configuration, and
wherein the SBFD resources are allocated in the second TDD pattern in accordance with a default SBFD window.

19. The method of claim 15, wherein the configuration allocates the SBFD resources in at least one of the first TDD pattern and a second TDD pattern in accordance with one or more periodicities.

20. An apparatus for wireless communication, comprising:
means for receiving a configuration for sub-band full duplex (SBFD) resources in at least a first time division duplexing (TDD) pattern;
means for transmitting an uplink communication in an SBFD slot or symbol in accordance with the SBFD resources; and
means for receiving a downlink communication in the SBFD slot or symbol in accordance with the SBFD resources.
